(19) United States
(12) Patent Application Publication
(10) Pub. No.: US 2013/0233991 A1
(43) Pub. Date: Sep. 12, 2013

(54) ADJUSTING DEVICE

(71) Applicants: WEI LIU, Shenzhen City (CN); XUE-DONG TANG, Shenzhen City (CN)

(72) Inventors: WEI LIU, Shenzhen City (CN); XUE-DONG TANG, Shenzhen City (CN)

(73) Assignees: HON HAI PRECISION INDUSTRY CO., LTD., Tu-Cheng (TW); HONG FU JIN PRECISION INDUSTRY (SHENZHEN) CO., LTD., Shenzhen City (CN)

(21) Appl. No.: 13/543,912

(22) Filed: Jul. 9, 2012

(30) Foreign Application Priority Data
Mar. 9, 2012 (CN) 201220086930.X

(51) Int. Cl. F16M 13/00

(52) U.S. Cl. 248/295.11

(57) ABSTRACT

An adjusting device for adjusting a height of an object, includes a support base, an adjusting portion movably secured to the support base and adapted for holding the object, a driving portion engaging with the adjusting portion, and a limiting mechanism. The adjusting portion is capable of rotating to drive the adjusting portion to move relative to the support base to adjust the height of the object. The limiting mechanism is adapted to prevent the adjusting portion from rotating when the adjusting portion is driven to move relative to the support base.

### BACKGROUND

1. Technical Field

The present disclosure relates to adjusting devices, and more particularly to an adjusting device for adjusting a height of an object relative to a support surface.

2. Description of Related Art

Referring to FIG. 3, an illustration of an adjusting device 300 for supporting an object 400. The adjusting device 300 includes a support base 330, a nut 310 secured to the support base 330, and a rod 320 threadedly engaging with the nuts 310 and used for holding the object 400. By rotating the rod 320 in clockwise (or anti-clockwise), the height of the object 400 is adjusted. However, when the rod 320 rotates, the object 400 rotates with the rod 320 simultaneously, which is infeasible and inconvenient when the object 400 is mounted to another object without rotating.

Therefore, there is room for improvement in the art.

### BRIEF DESCRIPTION OF THE DRAWINGS

The components of the drawings are not necessarily drawn to scale, the emphasis instead being placed upon clearly illustrating the principles of the embodiments of the adjusting device. Moreover, in the drawings, like reference numerals designate corresponding parts throughout several views.

FIG. 1 is a perspective view of an adjusting device in accordance with an embodiment.

FIG. 2 is a disassembled view of the adjusting device in FIG. 1.

FIG. 3 is a perspective view of an adjusting device in the prior art.

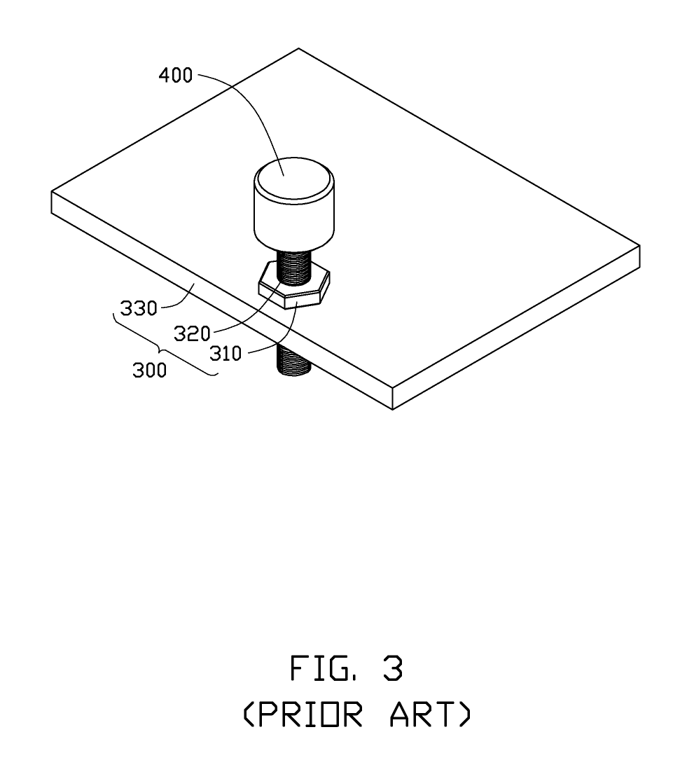

### DETAILED DESCRIPTION

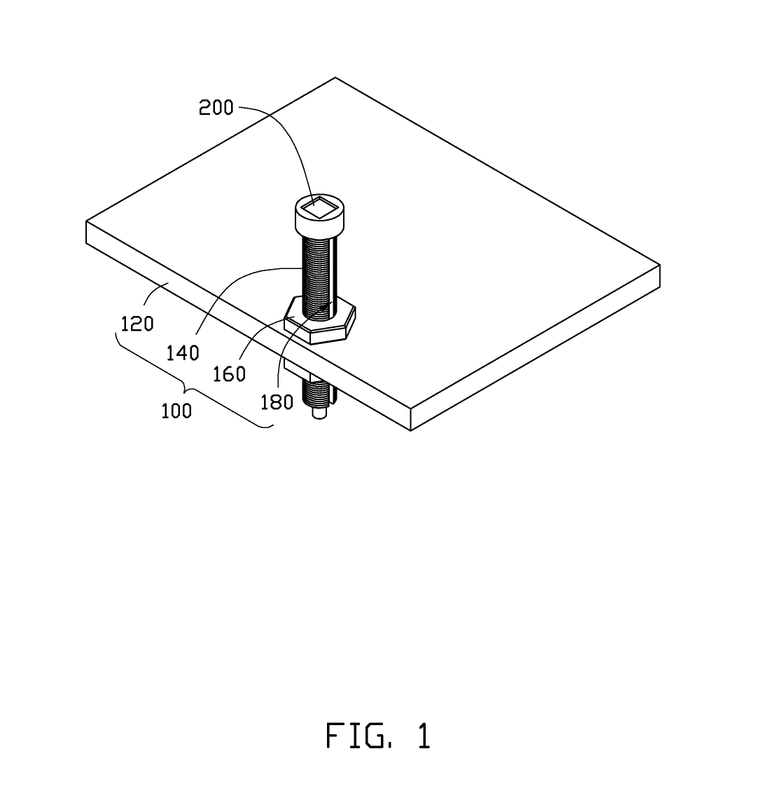

FIG. 1 is an adjusting device 100 of the present disclosure. The adjusting device 100 is adapted to adjust a height of an object 200 relative to a support surface, such as a table (not shown). The adjusting device 100 includes a support base 120, an adjusting portion 140 slidably coupled to the support base 120 and adapted to hold the object 200, a driving portion 160 engaging with the adjusting portion 140, and a limiting mechanism 180. The driving portion 160 is capable of rotating to drive the adjusting portion 140 moving in a direction perpendicular to the support base 120, such that the height of the object 200 relative to the support base 120 is adjusted. The limiting mechanism 180 is adapted to prevent the adjusting portion 140 from rotating when the adjusting portion 140 is driven to move by the driving portion 160.

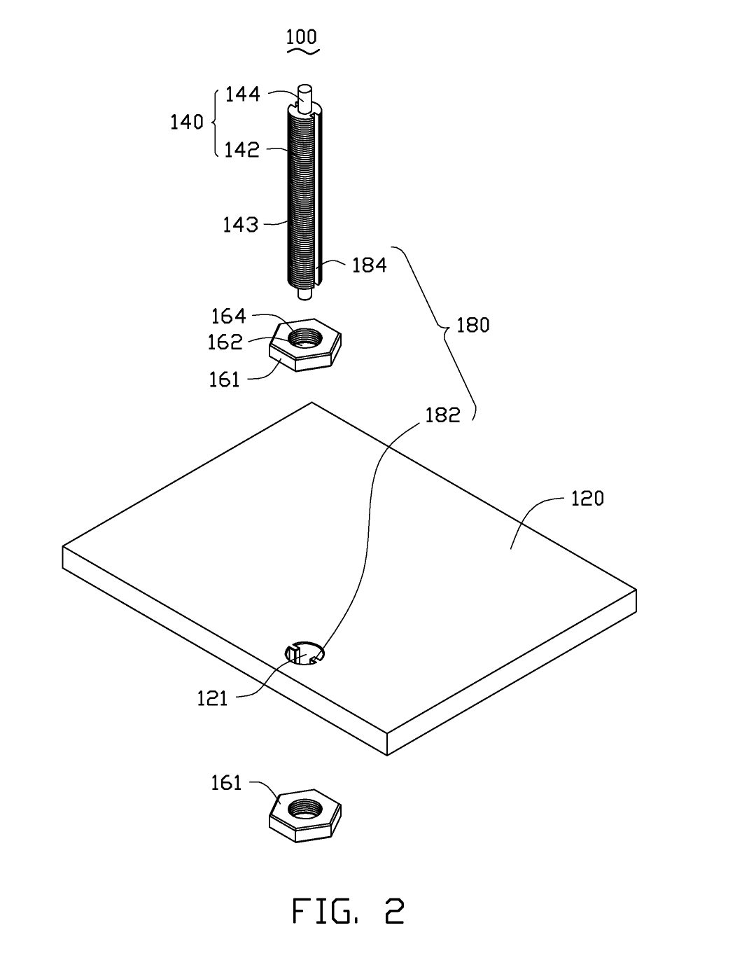

Referring to FIG. 2, the supporting base 120 is substantially rectangular. The supporting base 120 is mounted to a support surface, such as a table, to fix the adjusting device 100. The support base 120 defines a through hole 121. The through hole 121 is substantially round, and extends in a direction perpendicular to the support base 120.

The adjusting portion 140 is slidably received in the through hole 121. The adjusting portion 140 includes an adjusting post 142 and two fixing posts 144 fixed to opposite ends of the adjusting post 142. The adjusting post 142 is substantially cylindrical, and is slidably received in the through hole 121. The diameter of the adjusting post 142 is slight less than the diameter of the through hole 142. The adjusting post 142 defines a plurality of first threads 143. The fixing posts 144 are coaxial with the adjusting post 142, and are adapted to hold the object 200.

The driving portion 160 includes two nuts 161 in the embodiment. The nuts 161 threadedly engage with the adjusting post 142 and are arranged at opposite sides of the support base 120. The size of each nut 161 is less than the size of the through hole 121. Each nut 161 defines an engaging hole 162 for receiving the adjusting post 142. The inner surface of the engaging hole 162 defines a plurality of second threads 164. The second threads 164 mate with the first threads 143, such that the nuts 161 threadedly engage with the adjusting post 142. In other embodiment, the driving portion 160 includes only one nut 161 rotatably secured to the support base 120, and the distance between the nut 161 and the support base 120 is unchanged.

The limiting mechanism 180 includes at least one protrusion 182 arranged at the inner surface of the through hole 121 and at least one recess portion 184 arranged at the adjusting post 142 and corresponding to the at least one protrusion 182. The at least one recess portion 184 engages with the at least one protrusion 182 to prevent the adjusting portion 140 from rotating when the adjusting portion 140 is driven to move by the driving portion 160. In the embodiment, the limiting mechanism 180 includes two protrusions 182 and two recess portions 184 corresponding to the protrusions 182 respectively. The protrusions 182 are symmetrically arranged at the inner surface of the through hole 121. The recess portions 184 are defined at opposite sides of the adjusting post 142 and extend in a direction parallel to the adjusting post 142. When the adjusting portion 140 is received in the through hole 121, the recess portions 184 respectively receives the protrusions 182 to prevent the adjusting portion 140 from rotating.

Referring again to FIG. 2, in assembly, first, the adjusting post 142 is received in the through hole 121 with the protrusions 182 being respectively received in the recess portions 184. Second, the nuts 161 are threaded to the adjusting post 142 from opposite ends of the adjusting post 142 and further abut opposite sides of the support base 120, thus, the adjusting portion 140 is secured to the support base 120.

To increase the height of the object 200 relative to the support base 120: first, the nut above the support base (referred herein as the top nut) is unscrewed for a few or more than a few threads depending on the intended height to be increased; Second, rotate the nut 161 under the support base 120 (referred herein as the bottom nut) in a first direction (for example, anticlockwise), because the bottom nut is stopped by the support base 120, the adjusting post 142 is driven to move upwardly, and the height of the objected 200 relative to the support base 120 is increased. At the same time, the protrusions 182 engage with the recess portions 184 to prevent the adjusting post 142 from rotating relative to the support base 120. As a result, the height of the objected 200 relative to the support base 120 is increased with the object 200 without rotation. Furthermore, after the height of the object 200 is adjusted to a desired position, the top nut is operated to abut the support plate 120, and cooperates with the bottom nut to lock the adjusting portion 140 to position the object 200 in the desired position.

To decrease the height of the object 200 relative to the support base 120: first, the bottom nut is unscrewed for a few or more threads; Second, rotate the top nut in a second direction opposite to the first direction (for example, clockwise), because the top nut is stopped by the support base 120, the adjusting post 142 is driven to move downwardly, and the height of the objected 200 relative to the support base 120 is decreased. At the same time, the protrusions 182 engage with the recess portions 184 to prevent the adjusting post 142 from rotating relative to the support base 120. As a result, the height of the objected 200 relative to the support base 120 is decreased with the object 200 without rotation. Furthermore, after the height of the object 200 is decreased to a desired position, the bottom nut is operated to abut the support plate 120, and cooperates with the top nut to lock the adjusting portion 140 to position the object 200 in the desired position.

By assistance the adjusting device 100, the height of the object 200 is adjusted with the object 200 without rotation.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An adjusting device for adjusting height of an object, comprising:
a support base;
an adjusting portion movably secured to the support base and adapted for holding the object;
a driving portion engaging with the adjusting portion and capable of rotating to drive the adjusting portion move relative to the support base to adjust the height of the object; and
a limiting mechanism adapted to prevent the adjusting portion from rotating when the adjusting portion is driven to move relative to the support base.

2. The adjusting device of claim 1, wherein the limiting mechanism comprises at least one protrusion secured to the support base and at least one recess portion defined in the adjusting portion, the at least one recess portion corresponds to and receives the at least one protrusion to prevent the adjusting portion from rotating when the adjusting portion is driven to move relative to the support base.

3. The adjusting device of claim 2, wherein the support base defines a through hole for slidably receiving the adjusting portion, the at least one protrusion is secured to an inner surface of the through hole.

4. The adjusting device of claim 3, wherein the adjusting portion comprises an adjusting post defining a plurality of first threads, and at least one fixing post fixed to an end of the adjusting post and adapted to hold the object.

5. The adjusting device of claim 4, wherein the at least one recess portion is defined on the adjusting post.

6. The adjusting device of claim 4, wherein the diameter of the adjusting post is slightly less than the diameter of the through hole.

7. The adjusting device of claim 4, wherein the driving portion comprises at least one nut, the at least one nut define a plurality of second threads to threadedly engaging with the first threads.

8. The adjusting device of claim 7, wherein the at least one nut is further adapted to secure the adjusting portion to the support base.

9. An adjusting device for adjusting a height of an object, comprising:
a support base defining a through hole;
an adjusting portion slidably received in the through hole and adapted for holding the object; and
a driving portion engaging with the adjusting portion and capable of rotating to drive the adjusting portion move relative to the support base to adjust the height of the object;
wherein at least one protrusion is secured to an inner surface of the through hole, the adjusting portion defines at least one recess portion, the at least one recess portion corresponds to and receives the at least one protrusion to prevent the adjusting portion from rotating when the adjusting portion is driven to move relative to the support base, whereby the height of the object is adjusted with the object without rotation.

10. The adjusting device of claim 9, wherein the adjusting portion comprises an adjusting post defining a plurality of first threads, and at least one fixing post fixed to an end of the adjusting post and adapted to hold the object.

11. The adjusting device of claim 10, wherein the at least one recess portion is defined on the adjusting post.

12. The adjusting device of claim 10, wherein the diameter of the adjusting post is slightly less than the diameter of the through hole.

13. The adjusting device of claim 10, wherein the driving portion comprises at least one nut, the at least one nut define a plurality of second threads to threadedly engaging with the first threads.

14. The adjusting device of claim 13, wherein the at least one nut is further adapted to secure the adjusting portion to the support base.
